(19) United States
(12) Patent Application Publication
(10) Pub. No.: US 2005/0054347 A1
(43) Pub. Date: Mar. 10, 2005

(54) Uplink resource allocation

(76) Inventor: Naveen Kumar Kakani, Irving, TX (US)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/655,535

(22) Filed: Sep. 5, 2003

(51) Int. Cl. H04Q 7/20

(52) U.S. Cl. 455/452.1

(57) ABSTRACT

A method and apparatus for allocating uplink resources is provided. According to one embodiment, the method includes the steps of estimating the traffic in the uplink, and allocating resources based on the step of estimating. The uplink traffic estimation is achieved by observing the traffic properties in the downlink, and the traffic properties learned by the system.

### BACKGROUND OF THE INVENTION

1. Field of the invention

The invention relates to the allocation of resources in the uplink of a communication system. The invention relates particularly, but not exclusively, to the allocation of resources to a mobile station in a wireless/cellular communication system.

2. Description of the Related Art

In wireless/cellular networks, the network allocates resources to mobile stations (MSs) based upon the requirements of each MS and the overall system load. However continuous signaling between the MS and the network to indicate the resource request consumes a good proportion of the available bandwidth.

In radio systems where the allocation of radio resources for Uplink Direction (UL) data transfer is controlled by the network side (fixed wireline components), the network side components do not have an estimate of the amount of data to be sent at the MS side. For example in the case of Release 4 or Release 5 of the 3rd Generation Partnership Project (3GPP) specifications when a MS has data to send then it makes a request for resources to do so. Once the resources are allocated and the MS transmits the data that it had to send, the MS goes into an idle mode until there is any new data to send. If there is new data to send within a certain amount of time, and if the appropriate uplink resources are allocated by the network, then the MS can use the resources to send the new data.

However, if the network does not allocate the resources until a certain amount of time, the MS has to go through the resource allocation procedure, which involves signaling information. This adds to the overhead of the system. If the network allocates resources and there is no data to be sent at the MS side, then the radio resources are not utilized. Hence, if the network has knowledge of the amount of data to be sent by the MS, then it is possible to have good radio throughput.

In the prior art, allocating resources is done either based upon a timer or a round robin scheme, where all the mobile stations are given resources sequentially.

### SUMMARY OF THE INVENTION

In one embodiment, the invention provides a method of allocating uplink resources. The method includes the steps of estimating the traffic in an uplink, and allocating resources based on the step of estimating.

According to another embodiment, the invention provides a communication system including an estimating mechanism and an uplink allocation resource mechanism. The estimating means estimate the traffic in an uplink. The uplink allocation resource allocates the uplink resources based on an estimate determined by the estimate mechanism.

One of the advantages of the invention is that, instead of allocating uplink resources on a round-robin basis or on a predefined priority basis, using the knowledge of the uplink traffic at the network side enables better allocation of radio resources. Since this feature provides the network with an estimate of the amount of data that is expected to be sent in the uplink, the radio resources may be used optimally.

### BRIEF DESCRIPTION OF THE DRAWINGS

FIG. 1 illustrates an example system architecture in which the invention may be advantageously implemented;

FIG. 2 illustrates an example of a TCP session for a bulk data type transfer; and

FIG. 3 illustrates an example of a TCP session for an interactive TCP data transfer.

### DETAILED DESCRIPTION OF THE PREFERRED EMBODIMENTS

The invention is described herein by way of reference to particular example implementations. However, one skilled in the art will appreciate that the invention is not limited to such implementations.

The invention may be implemented in various different applications. For each application the methodology to implement the invention is different. In the present description examples are described based on a TCP application.

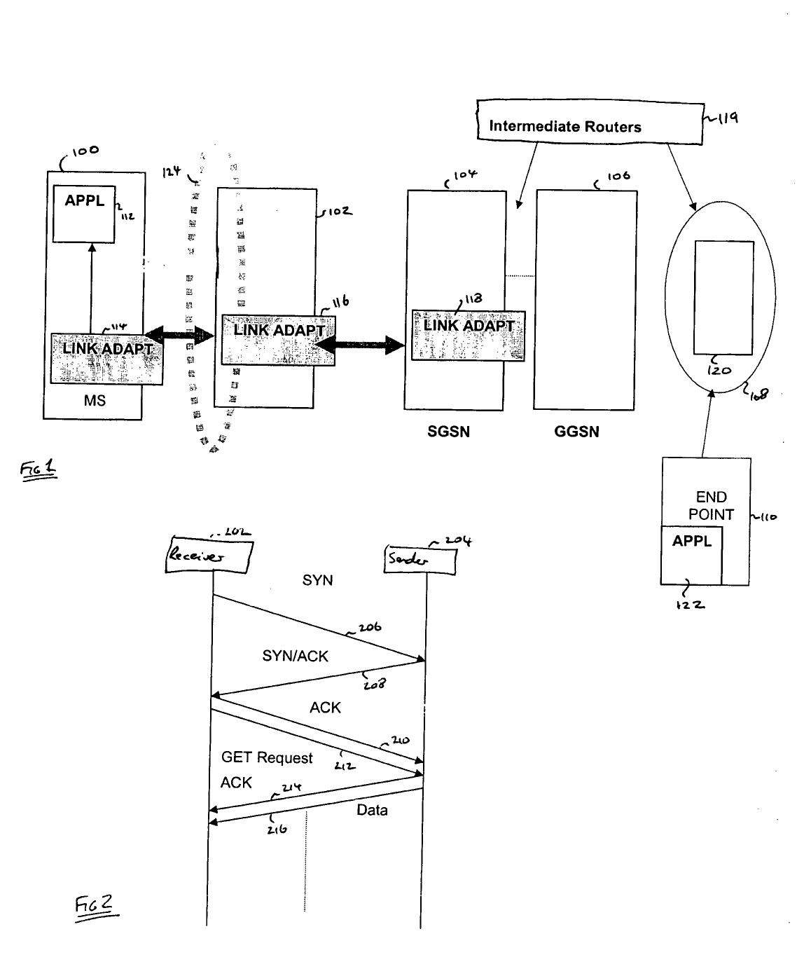

FIG. 1 shows an example of a system architecture and the mapping of an estimation algorithm in a LINK_ADAPT module providing link-adapt functionality, as described further below. In the described embodiments, an algorithm is proposed for implementing the invention, which is preferably implemented in the so-called LINK_ADAPT section of the architecture.

Referring to the example of FIG. 1, the system architecture may include a mobile station (MS) 100, a radio access network (RAN) 102, a Serving GPRS Support Node (SGSN) 104, a Gateway GPRS Support Node (GGSN) 106, an intermediate router 119, an end-point 110, and an end-point connector 108. The MS 100 may include an application functional block 112, and a link-adapt functional block 114. The RAN 102 may include a link-adapt functional block 116, although in practice the link-adapt functionality may be distributed within the RAN 102. The SGSN 104 may include a link-adapt functional block 118. The end-point connector 108 may include a routing switch 120. The end-point 110 includes an application functional block 122.

The MS 100 is connected to the RAN 102 via an air interface, generally represented by the dashed line 124. The link-adapt functional block 114 of the MS 100 connects with the link-adapt functional block 116 of the RAN 102 over the air-interface. The link-adapt functional block 116 of the RAN 102 is connected to the link-adapt functional block 118 of the SGSN 104. THE SGSN 104 is connected to the GGSN 106 and the intermediate routers 119. The intermediate routers connect to the connector 108, which in turn connects to the end-point 110.

In the downlink (DL), traffic is transferred from the end-point 110 toward the MS 100, and in the uplink traffic is transferred from the MS 100 toward the end-point 110. The RAN 102, SGSN 104 and the GGSN 106 may generally be considered to make up the network.

In accordance with the invention, the amount of data queued up in the MS 100 i.e., an amount of data to be sent in the uplink direction, is estimated in order to improve the management of the uplink resources from the network. The estimated value allows the network to schedule radio resources in the uplink direction to the MS to meet the quality of service (QoS) requirements of the traffic. The estimation technique is independent of the radio technology utilized, and the concepts are based on the type of application and the type of data that is being carried.

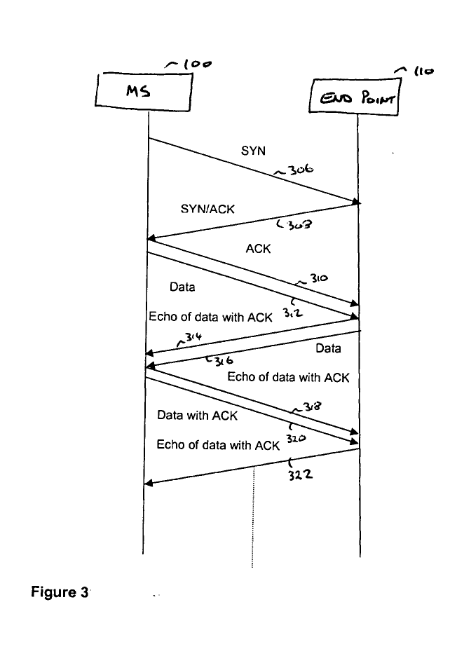

With reference to FIGS. 2 and 3, two example applications are described for TCP applications. TCP applications can be broadly classified into interactive type data transfer and bulk data transfer applications. A bulk data type transfer is described with reference to FIG. 2 and an interactive type data transfer is described with reference to FIG. 3.

FIG. 2 shows an example of TCP session showing the sequence of message exchanges in the case of a bulk TCP data transfer. The characteristics of a bulk TCP traffic request may include:
Typically either the uplink or the downlink has more data to send than the other. If the MS is downloading any information, then there is more data in the downlink direction. Otherwise the uplink has more data to send than the downlink.

On the side of the system from where the data is being downloaded from, typically the size of the data segments is the maximum segment size.

The applications are time sensitive, but they are in the order of a few tens of seconds.

Referring to FIG. 3, there is illustrated an example in which data is transferred from the MS 100 to the network end-point 110. That is, FIG. 2 illustrates an example of a data transfer in the uplink. For the purposes of this example, the MS 100 is the sender and the end-point 110 is the receiver. At the beginning of such transfer, the network does not know the size of data to be transmitted to it, and therefore does not accurately know amount of the uplink resources to be allocated to the MS.

Referring to the example shown in FIG. 2, the receiver 202 (end-point 110) initiates a TCP connection by transmitting a synchronization signal SYN 206 to the sender 204 (MS 100). On successful reception of the synchronization signal SYN 206, the sender 204 (MS 100) transmits a synchronization acknowledgement signal SYN/ACK 208 to the receiver 202 (end-point 110) acknowledging correct receipt. The synchronization acknowledgement signal may include additional TCP parameters.

The receiver 202 (end-point 110) then transmits an acknowledgement signal ACK 210 acknowledging successful receipt of the synchronization acknowledgement signal SYN/ACK 208 to the sender 204 (MS 100).

Parallel with the acknowledgement signal ACK 210, or shortly thereafter, the receiver 202 (end-point 110) sends a request signal GET Request 212 in order to retrieve the data. Responsive to successful receipt of the GET Request 212, the sender 204 (MS 100) sends an acknowledgement signal ACK 214 acknowledging safe receipt of the request to the receiver 202 (end-point 110).

Parallel with the acknowledgement signal ACK 214, or shortly thereafter, the sender 204 (MS 100) sends the data 216 to the receiver 202 (end-point 110). This sequence continues such that on successful receipt of each data packet the receiver 202 sends an acknowledgement signal to the sender 204. Responsive to such acknowledgement signal the sender sends the next clock of data to the receiver 202. This process continues as long as there is data remaining to be sent.

In this embodiment, the invention is utilized in the network by assuming, upon the transmission of an acknowledgement signal to the MS, that a further data block will be received from the MS. The network therefore allocates resources to the MS based on the resources required for the previous block of data. If no further data is to be sent by the MS, after the transmission of the last acknowledgement signal, then the network will time out and a connection termination procedure is initiated.

Thus, in accordance with this embodiment of the invention, the data or traffic in the uplink is estimated based on the last data received in the uplink. As discussed, in the uplink, where the MS is the sender and the end point is the receiver, in the case of a bulk TCP data transfer for every data packet sent in the uplink there is an acknowledgement in the opposite direction. For every acknowledgement seen in the downlink direction, multiple TCP segments can be expected in the UL direction. Thus in this embodiment the estimate of the uplink resources relies upon an assumption that after acknowledging one data block, a further data block will be received.

FIG. 2 describes an example of a bulk TCP data transfer where the data transfer takes place in the uplink. The invention may also be applied, for example, where the data transfer takes place in the downlink. In the downlink scenario, the end-point 110 is the sender 204 and the MS 100 is the receiver 202. After the connection is set-up, for every data segment sent in the downlink an acknowledgement packet can be expected in the uplink. Thus the amount of data in the uplink is the amount required to transmit an acknowledgement signal, and this allows the uplink resources to be estimated and appropriately allocated to the MS.

FIG. 3 shows an example of a TCP session showing the sequence of messages for an interactive TCP data transfer. Interactive TCP sessions are initiated by the MS. This example is used to present an uplink data estimation algorithm. The characteristics of an interactive type TCP data transfer application may include:
The traffic requests may have more or less equal amount of data traffic transfer both in the uplink and the downlink.
Traffic requests may be time sensitive.
Traffic requests may not have a huge amount of data, i.e., much less than 1K segments, to send in one instance.

FIG. 3 illustrates an example of an interactive TCP session. In a set-up procedure, the MS 100 sends a synchronization signal SYN 306 to the end-point 110. In response, the end-point sends a synchronization acknowledgement signal SYN/ACK 308 to the MS 100. The MS 100 then sends an acknowledgement signal ACK 310 to the endpoint 110.

In parallel with the acknowledgement signal 310, or shortly thereafter, the MS 100 sends a data block 312 to the endpoint 110. The endpoint 110 acknowledges receipt of such data by transmitting an acknowledgement signal ACK 314 together with a data block 316 to the MS 100. Responsive to receipt of the data 316, the MS 100 sends an acknowledgement signal 318 together with a further block of data to the end point 110. Responsive thereto, the endpoint 110 sends an acknowledgement signal 322 to the MS 100.

Thus in the embodiment of interactive TCP data transfer, use is made of the balance of the data in both directions in order to estimate the traffic in the uplink. Upon transmission of a data packet in the downlink, the network can estimate that a similar sized data packet and an acknowledgement will be transmitted in the uplink. The network can allocate uplink resources accordingly. This feature of the invention relies upon the fact that, in the interactive type TCP of the data transfer, data is exchanged in both directions and is of similar size in both directions.

For every packet sent in the downlink direction there is an acknowledgement sent together with the data. It may not be possible to determine the exact value of the amount of data to be sent in the uplink, but it can be estimated to be the same as the amount of data sent in the downlink, with an acknowledgement field attached.

Since the amount of interactive data is of the order of hundreds of bytes, even an incorrect estimate may be corrected from the data sent in the uplink. For example, in the case of a GSM/Edge Radio Access Network (GERAN) system each uplink packet has a CV (count down value) field (4 bit field) which carries the number of Radio Link Control (RLC) blocks at the MS side accurately up to 15 blocks.

According to one embodiment, the invention estimates and allocates radio resources to the mobile station to enable uplink data transmission. However it is not always possible to accurately estimate the data to be sent. Hence, the invention assists in the initial allocation of the resources and the actual resource requirement can be understood while the data transaction is progress and the resources can be modified as needed. This technique of the invention is more favorable in comparison with a round-robin scheme, which is used in existing systems and where the mobile station has to wait until it's next turn even if it has data to send, since the network side may not have an idea that the mobile station may have data to send.

The estimation associated with the invention takes place on the network side of a communication system. In a UMTS or CDMA system, the estimation feature in accordance with the invention may be implemented in the link-adapt functional block 116 of the RAN 102. In a 2G or 2.5G system, where there may be no entity in the RAN 102 between the mobile station and the SGSN 104 which has any knowledge about the IP layer, TCP layer, or higher layers. Thus, the estimation of the invention may be implemented in the link-adapt functional block 118 of the SGSN in such a system. In such a system, the SGSN sends LLC frames to the RAN, which in turn transmits the data to the mobile station as RLC radio blocks.

According to one embodiment, the invention provides a technique for allocating radio resources in the uplink.

According to a further embodiment of the invention, the traffic may be associated with a bulk TCP uplink data transfer, the traffic in the uplink for a given transfer block being estimated to be the same as for the previous transfer block.

The traffic may be associated with a bulk TCP downlink data transfer wherein the traffic in the uplink for a given transfer block is estimated to be an acknowledgement of the traffic in the downlink.

The traffic may be associated with an interactive TCP data transfer, and the traffic in the uplink is estimated to be the same as the traffic in the downlink. The traffic in the uplink may be further estimated to include an acknowledgement of the traffic in the downlink.

The estimate of the uplink may be dependent upon the downlink traffic. The uplink traffic may be estimated to be the same as the downlink traffic. The uplink traffic may be estimated to be an acknowledgement of the downlink traffic. The uplink traffic may be estimated to be the same as the downlink traffic together with an acknowledgement of the downlink traffic.

The traffic may be associated with a bulk TCP uplink data transfer. An estimating device may be adapted to estimate the traffic in the uplink. The estimating device may be further adapted to estimate the traffic in the uplink for a given transfer block to be the same as for the previous transfer block.

The traffic may be associated with a bulk TCP downlink data transfer. The estimating device may be adapted to estimate the traffic in the uplink. The estimating device may be further adapted to estimate the traffic in the uplink for a given transfer block to be an acknowledgement of the traffic in the downlink.

The traffic may be associated with an interactive TCP data transfer, and the estimating device may be adapted to estimate the traffic in the uplink. The estimating device may be further adapted to estimate the traffic in the uplink for a given transfer block to be the same as the traffic in the downlink.

The traffic in the uplink may be further estimated to include an acknowledgement of the traffic in the downlink. The estimate device may be adapted to estimate the traffic in the uplink and the estimate device may be adapted to be dependent upon the downlink traffic. The uplink traffic may be estimated to be the same as the downlink traffic. The uplink traffic may be estimated to be an acknowledgement of the downlink traffic.

The uplink traffic may be estimated to be the same as the downlink traffic together with an acknowledgement of the downlink traffic.

The communication system according to one embodiment may include a mobile communication system in which the estimate device may be adapted to estimate the traffic in the uplink and the uplink allocation resources are provided in a radio access network.

The communication system may include a mobile communication system in which the estimate device which may be adapted to estimate the traffic in the uplink and the uplink allocation resources are provided in a serving GPRS support node.

According to another embodiment, the invention estimates the amount of data queued up in the Mobile Station (MS) i.e., the amount of data to be sent in the UL direction. The estimated value allows the network side to schedule radio resources in the UL direction to the MS to meet the QoS requirements of the traffic. The method and apparatus of the invention are independent of the radio technology and the concepts are based on the type of application whose data is being carried. Any required changes are on the network side and do not require any standardization.

Traffic flows of different applications have a specific message exchange procedure. Based on the type of application and the data sent in the DL, embodiments of the invention provide for an estimate of the amount of data to be sent in the uplink. For example, in a bulk data transfer using TCP knowledge of the amount of data in the uplink is derived from the downlink. That is, if a TCP data segment is sent then an acknowledgement for that segment is received. Knowledge of the uplink data estimate can be used to allocate radio resources in the uplink which result in better radio throughput.

The invention has been described herein with particular reference to examples, and particularly TCP examples. The invention is not limited to such examples, and one skilled in the art will appreciate that the invention is more broadly applicable. The scope of the protection afforded by the invention is defined in the appended claims.

1. A method of allocating uplink resources, comprising:
estimating traffic in an uplink; and
allocating resources based on said step of estimating.

2. A method according to claim 1, further comprising:
associating the traffic with a bulk TCP uplink data transfer, and
estimating the traffic in the uplink for a given transfer block to be identical as for a previous transfer block.

3. A method according to claim 1, further comprising:
associating the traffic with a bulk TCP downlink data transfer, and
wherein the estimating step comprises estimating the traffic in the uplink for a given transfer block to be an acknowledgement of the traffic in a downlink.

4. A method according to claim 1, further comprising:
associating the traffic with an interactive TCP data transfer, and
wherein the step of estimating comprises estimating the traffic in the uplink to be identical to the traffic in a downlink.

5. A method according to claim 4 wherein the step of estimating comprises estimating the traffic in the uplink to include an acknowledgement of the traffic in a downlink.

6. A method according to claim 1 wherein the step of estimating comprises estimating the uplink based upon a downlink traffic.

7. A method according to claim 6 wherein the step of estimating comprises estimating an uplink traffic to be an identical as a downlink traffic.

8. A method according to claim 6 wherein the step of estimating comprises estimating an uplink traffic to be an acknowledgement of the downlink traffic.

9. A method according to claim 6 wherein the step of estimating comprises estimating an uplink traffic to be identical as a downlink traffic together with an acknowledgement of the downlink traffic.

10. A communication system comprising:
estimating means for estimating traffic in an uplink; and
uplink allocation resource means for allocating uplink resources based on said estimating means.

11. A communication system according to claim 10 wherein
the traffic is associated with a bulk TCP uplink data transfer, and
the estimating means uplink is further configured to estimate the traffic in the uplink for a given transfer block to be identical as a previous transfer block.

12. A communication system according to claim 10, wherein
the traffic is associated with a bulk TCP downlink data transfer, and
the estimating means uplink being further configured to estimate the traffic in the uplink for a given transfer block to be an acknowledgement of the traffic in a downlink.

13. A communication system according to claim 10, wherein
the traffic is associated with an interactive TCP data transfer, and the estimating means uplink being further configured to estimate the traffic in the uplink for a given transfer block to be identical as the traffic in a downlink.

14. A communication system according to claim 13 wherein the traffic in the uplink is further estimated to include an acknowledgement of the traffic in a downlink.

15. A communication according to claim 10 wherein the estimating means is configured to be dependent upon a downlink traffic.

16. A communication system according to claim 15 wherein the uplink traffic is estimated to be identical as the downlink traffic.

17. A communication system according to claim 15 wherein the uplink traffic is estimated to be an acknowledgement of the downlink traffic.

18. A communication system according to claim 15 wherein the uplink traffic is estimated to be identical as the downlink traffic together with an acknowledgement of the downlink traffic.

19. A communication system according to claim 10, further comprising:
a mobile communication system in which the estimating means uplink and an uplink allocation resource are provided in a radio access network.

20. A communication system according to claim 10, further comprising:
a mobile communication system in which the estimating means uplink and an uplink allocation resource are provided in a serving General Packet Radio Service support node.
